(19) United States
(12) Patent Application Publication
(10) Pub. No.: US 2017/0295086 A1
(43) Pub. Date: Oct. 12, 2017

(54) SINGLE TIER ROUTING

(71) Applicant: Dell Software Inc., Round Rock, TX (US)

(72) Inventors: Karl Dyszynski, Lynnwood, WA (US); Steven C. Work, Bellingham, WA (US)

(21) Appl. No.: 15/217,794

(22) Filed: Jul. 22, 2016

Related U.S. Application Data
(60) Provisional application No. 62/321,655, filed on Apr. 12, 2016.

(51) Int. Cl. H04L 12/751; H04L 29/08; H04L 12/26

(52) U.S. Cl. CPC H04L 45/02; H04L 43/0876; H04L 67/1002; H04L 43/04

(57) ABSTRACT

A single global traffic optimizer can be configured to perform the functionality of a global and local traffic manager. For example, the global traffic optimizer can receive a client request from a client device and route the client request to an appropriate service provider from a set of geographically dispersed service providers to service the client request. In addition to the geographic location data of the client device and service providers, the global traffic optimizer can also analyze health metrics describing service quality of the various service providers, such as Central Processing Unit (CPU) usage, bandwidth, memory usage, connectivity, service provider's network status, network latency, user capacity saturation, etc. Based on an analysis of this data, the global traffic optimizer can determine the service provider that is best suited to service the client request and route the client request accordingly without need for a local traffic manager.

### CROSS-REFERENCE TO RELATED APPLICATIONS

This application claims the priority benefit of U.S. provisional application No. 62/321,655, filed on Apr. 12, 2016, which is expressly incorporated by reference herein in its entirety.

### BACKGROUND OF THE INVENTION

### Field of the Invention

The present technology pertains to network routing services, and more specifically pertains to single tier routing.

### Description of the Related Art

Current networking systems rely on two tier routing systems that utilize a separate global traffic manager and local traffic manager to route client requests. A global traffic manager can field a client request and route the client requests to an appropriate local traffic manager, usually based on geographic location. For example, local traffic managers can be located at geographically dispersed data centers and the global traffic manager can route a client request to the local traffic manager that is geographically closest to the client device. The local traffic manager then decides which co-located service provider within the data center is best to service the request. Although the local traffic manager can select a co-located service provider based on real-time data gathered from the co-located service providers, the global traffic manager is limited to selecting a local traffic manager based solely on geographic location. Accordingly, improvements are needed.

### SUMMARY OF THE CLAIMED INVENTION

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for single tier routing. A global traffic optimizer can be configured to perform the functionality of a global and local traffic manager. For example, the global traffic optimizer can receive a client request from a client device and route the client request to an appropriate service provider from a set of geographically dispersed service providers to service the client request. In addition to the geographic location data of the client device and service providers, the global traffic optimizer can also analyze health metrics describing service quality of the various service providers, such as Central Processing Unit (CPU) usage, bandwidth, memory usage, connectivity, service provider's network status, network latency, user capacity saturation, etc. Based on an analysis of this data, the global traffic optimizer can determine the service provider that is best suited to service the client request and route the client request accordingly without need for a local traffic manager.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of computing devices and a network in accordance with the invention.

FIG. 2 shows an example method embodiment for single tier routing.

FIGS. 3A and 3B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for single tier routing. A global traffic optimizer can be configured to perform the functionality of a global and local traffic manager. For example, the global traffic optimizer can receive a client request from a client device and route the client request to an appropriate service provider from a set of geographically dispersed service providers to service the client request. In addition to the geographic location data of the client device and service providers, the global traffic optimizer can also analyze health metrics describing service quality of the various service providers, such as Central Processing Unit (CPU) usage, bandwidth, memory usage, connectivity, service provider's network status, network latency, user capacity saturation, etc. Based on an analysis of this data, the global traffic optimizer can determine the service provider that is best suited to service the client request and route the client request accordingly without need for a local traffic manager.

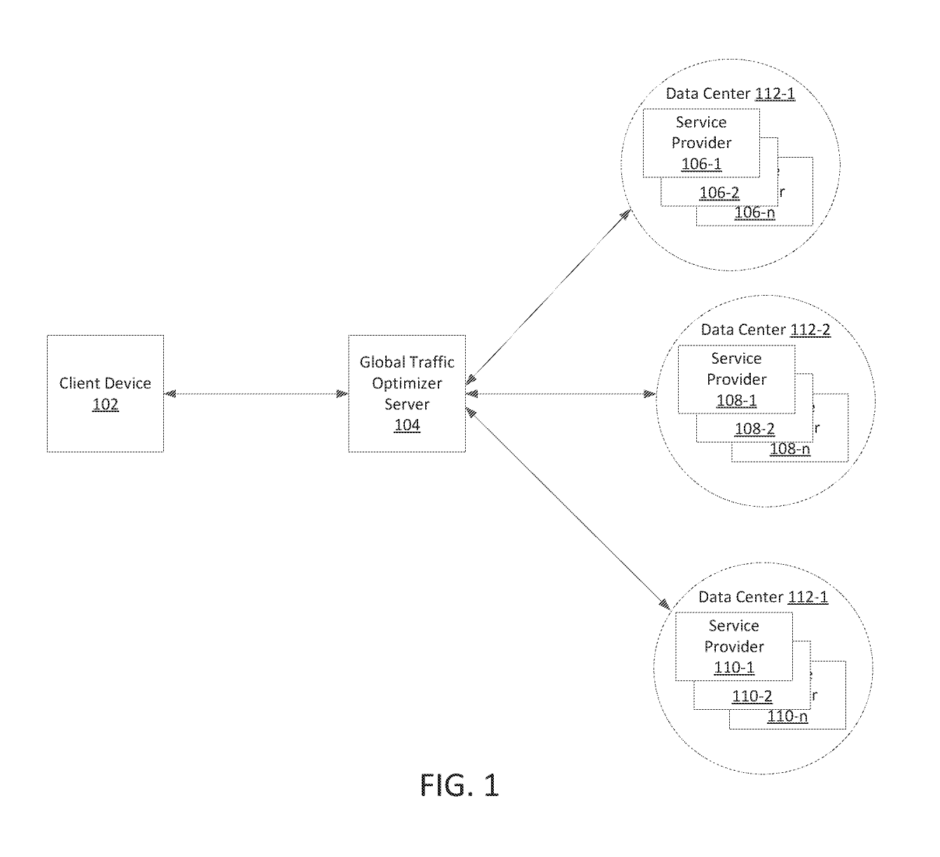

FIG. 1 shows an exemplary configuration 100 of computing devices and a network in accordance with the invention. The computing devices can be connected to a communication network and be configured to communicate with each other through use of the communication network. A communication network can be any type of network, including a local area network (“LAN”), such as an intranet, a wide area network (“WAN”), such as the internet, or any combination thereof. Further, a communication network can be a public network, a private network, or a combination thereof. A communication network can also be implemented using any number of communication links associated with one or more service providers, including one or more wired communication links, one or more wireless communication links, or any combination thereof. Additionally, a communication network can be configured to support the transmission of data formatted using any number of protocols.

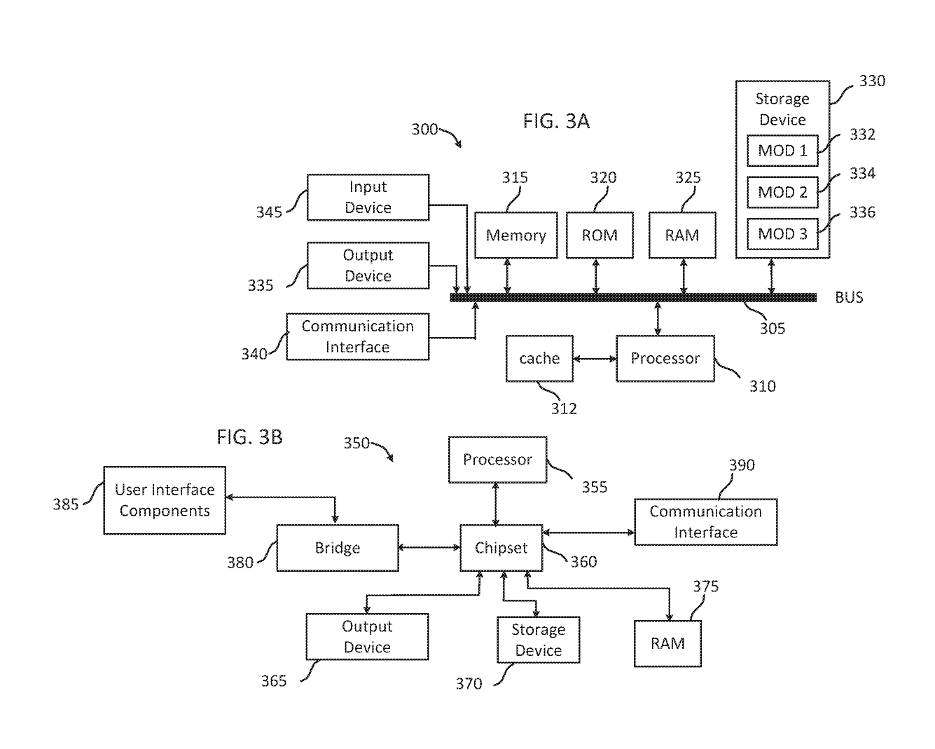

A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 300 of FIGS. 3A and 3B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As shown, system 100 includes multiple computing devices (e.g., client device 102, global traffic optimizer 104 and service providers 106₁, 106₂ . . . 106ₙ (collectively 106), service providers 108₁, 108₂ . . . 108ₙ (collectively 108), and service providers 110₁, 110₂ . . . 110ₙ (collectively 110). Although only these computing devices are shown in system 100, this is just one example and is not meant to be limiting. System 100 can include any number client devices, global traffic optimizers or service providers.

As shown, service providers 106, 108 and 110 can be located at a different one of data centers 112₁, 112₂ and 112₃ (collectively 112). For example, service providers 106 can be located at data center 112₁, service providers 108 can be located at data center 112₂ and service provider 110 can be located at data center 112₃. Each of data centers 112 can be at different geographic locations. For example data center 112₁ can be located in California, data center 112₂ can be located in Texas and data center 112₃ can be located in New York.

In system 100, a user can use client device 102 to transmit a request for a service provided by one or more of service providers 106, 108 and 110. Service providers 106, 108 and 110 can be computing servers that provide specified services or, alternatively, proxy access devices that forward client requests to an appropriate back end server that provides the requested services.

Global traffic optimizer 104 can be configured to receive a client request from client device 102 and route the client request to one of service providers 106, 108 or 110 to provide the requested service. For example, global traffic optimizer 104 can determine which one of service providers 106, 108 or 110 is the optimal service provider to service the client request and route the client request accordingly. Although global traffic optimizer 104 is shown as being separate than service providers 106, this is simply for ease of description. In some embodiments, global traffic optimizer 104 can be redundantly implemented at one or more of service providers 106, 108 and 110.

To determine which service provider is optimal to service the client request, global traffic optimizer 104 can analyze multiple factors, such as the geographic location of client device 102, the geographic locations of data centers 112, and health metrics describing service quality of service providers 106, 108 and 110. Health metrics can include Central Processing Unit (CPU) usage, bandwidth, memory usage, connectivity, service providers network status, network latency, user capacity saturation, etc.

Based on an analysis of this data, global traffic optimizer 104 can determine which service provider from service provider 106, 108 and 110 is best suited to service the client request and route the client request accordingly. Global traffic optimizer 104 can periodically gather health metrics form service providers 106, 108 and 110. For example, global traffic optimizer 104 can periodically query service providers 106, 108 and 110 for health metrics. Service providers 106, 108 and 110 can also periodically transmit or broadcast their health metrics to global traffic optimizer 104. In some embodiments, a central management system (not shown) can gather health metrics from service providers 106, 108 and 110, and periodically update global traffic optimizer 104 with the health metrics.

Upon receiving a client request from client 102, global traffic optimizer 104 can initially identify a set of service providers from service providers 106, 108 and 110 that are capable of servicing the request. This can include multiple service providers located at a single data center 112, service providers located at different data centers 112, or a combination of both. Global traffic optimizer 104 can then gather health metrics for the identified set of service providers as well as location information for the service providers (e.g., location of their corresponding data center 112) and client device 102. Global traffic optimizer 104 can then use this gathered data to determine an optimal service provider 106 from the set of service providers to service the request. Global traffic optimizer 104 can determine the optimal service provider in numerous ways, such as calculating an overall score, ranking for the service providers, applying various weights to the different factors, etc.

In some embodiments, global traffic optimizer 104 can calculate a health score for a service provider based on individual scores calculated for individual health metrics gathered from the service provider, such as CPU usage, bandwidth, memory usage, connectivity, etc. For example, global traffic optimizer 104 can calculate a first score based on a first health metric received from a service provider, calculate a second score based on a second health metric received from the service provider, and then calculate a health score for the service provider based on the first score and the second score.

In some embodiments, global traffic optimizer 104 can apply varying weights to the individual scores to calculate the health score for a service provider. The weights can be used to prioritize health metrics considered to be of more importance in determining the health of a service provider. For example, a weight can be a multiplier applied to an individual score for a specific health metric. A multiplier greater than one can be used to provide additional value to the individual score for a health metric considered to be of greater importance in determining the health of a service provider. In contrast, a multiplier less than one can be used to provide less value to an individual score for a health metric considered to be of lesser importance in determining the health score for a service provider. When calculating the health score for a service provider, global traffic optimizer 104 can apply a first weight to a first score and a second weight to a second score. The network routing server can then use the weighted individual scores to calculate the health score for the service provider.

In some embodiments, the central management system can calculate the health scores and provide them to the global traffic optimizer. The global traffic optimizer can then use the provided health scores to select the optimal service provider.

After determining the optimal service provider to service the request, global traffic optimizer 104 can route the client request to the selected service provider 106 for servicing. By utilizing a single tier routing approach with the use of global traffic optimizer 104, a separate local traffic manager is not needed at data centers 108. Further, the single tier approach allows global traffic optimizer 104 to route client requests based on geographic location data and health metric data, whereas a global traffic manager in a two tier approach can only utilize location data. Accordingly, global traffic optimizer 104 can determine an optimal service provider from service providers 106, 108 and 110 to service a client request based on location data and health metrics of service providers 106, 108 and 110.

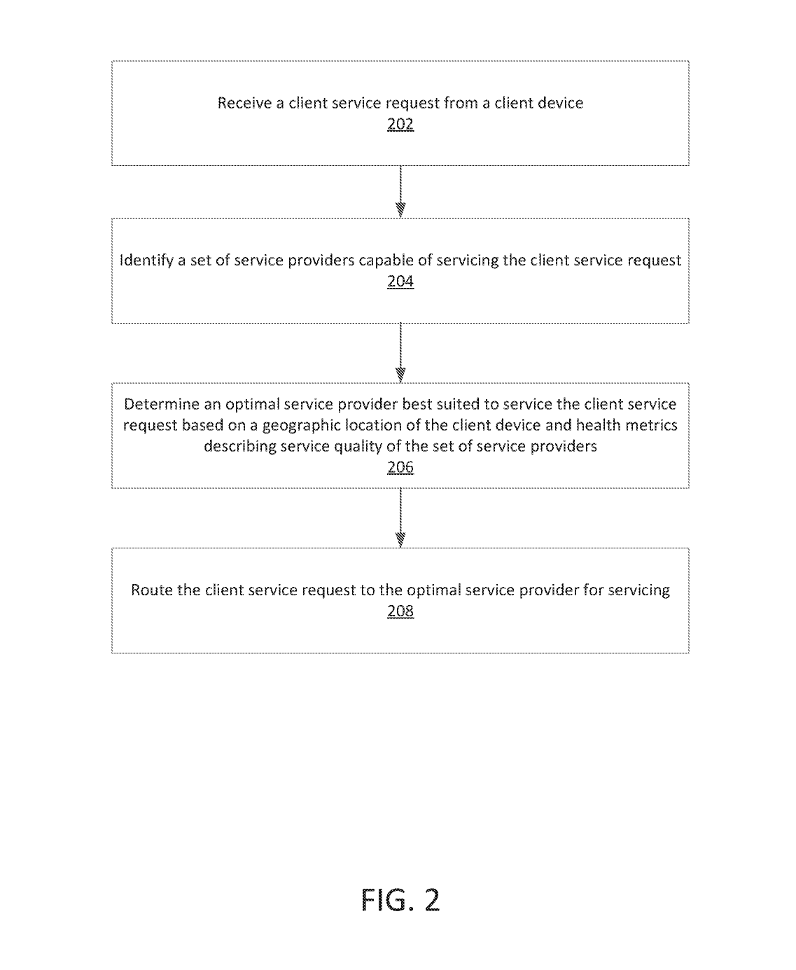

FIG. 2 illustrates an example method embodiment of selecting an optimal service provider to service a request. It should be understood that there can be additional, fewer, or alternative steps performed in similar or alternative orders, or in parallel, within the scope of the various embodiments unless otherwise stated.

At step 202, a global traffic optimizer can receive a client service request from a client device. The client service request can be a request for a service that can be provided by one or more service providers.

At step 204, the global traffic optimizer can identify a set of service providers capable of servicing the client service request. The set of service providers can include at least a first service provider located at a first data center and a second service provider located at a second data center. The first data center and the second data center can be located at different geographic locations. The set of service providers can also include multiple service providers located at the first data center and/or second data center.

At step 206, the global traffic optimizer can determine an optimal service provider best suited to service the client service request based on a geographic location of the client device and health metrics describing service quality of the set of service providers. Health metrics can include at least one of Central Processing Unit (CPU) usage, bandwidth, memory usage, connectivity, service providers network status, network latency or user capacity saturation. The global traffic optimizer can transmit requests to the set of service providers capable of servicing the client request for the health metrics, and receive the health metrics from the set of service providers in response to the requests. Alternatively, the global traffic optimizer can receive the health metrics from a central management system configured to gather health metrics from the service providers and periodically update the global traffic optimizer.

The global traffic optimizer can determine the optimal service provider by calculating health scores for each service provider from the set of service providers based on the health metrics received from the set of service providers and selecting the optimal service provider based on the health scores for each service provider. For example, the global traffic optimizer can select a service provider with the highest health score as the optimal service provider.

In some embodiments, the global traffic optimizer can calculate the health score for a service provider by calculating a first score based on a first health metric received from the service provider, calculating a second score based on a second health metric received from the service provider, and calculating the health score for the first service provider based on the first score and the second score.

In some embodiments, the central management system can calculate the health scores and provide them to the global traffic optimizer. The global traffic optimizer can then use the provided health scores to select the optimal service provider.

At step 208, the global traffic optimizer can route the client service request to the optimal service provider for servicing. This can include receiving a set of requested data from the optimal service provider in response to the client request, and transmitting the set of requested data to the client device. Alternatively, the optimal service provider can transmit the set of requested data directly to the client device.

FIGS. 3A and 3B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 3A illustrates a conventional system bus computing system architecture 300 wherein the components of the system are in electrical communication with each other using a bus 305. Exemplary system 300 includes a processing unit (CPU or processor) 310 and a system bus 305 that couples various system components including the system memory 315, such as read only memory (ROM) 320 and random access memory (RAM) 325, to the processor 310. The system 300 can include a cache of high-speed memory connected directly with, in close proximity to, or integrated as part of the processor 310. The system 300 can copy data from the memory 315 and/or the storage device 330 to the cache 312 for quick access by the processor 310. In this way, the cache can provide a performance boost that avoids processor 310 delays while waiting for data. These and other modules can control or be configured to control the processor 310 to perform various actions. Other system memory 315 may be available for use as well. The memory 315 can include multiple different types of memory with different performance characteristics. The processor 310 can include any general purpose processor and a hardware module or software module, such as module 1 332, module 2 334, and module 3 336 stored in storage device 330, configured to control the processor 310 as well as a special-purpose processor where software instructions are incorporated into the actual processor design. The processor 310 may essentially be a completely self-contained computing system, containing multiple cores or processors, a bus, memory controller, cache, etc. A multi-core processor may be symmetric or asymmetric.

To enable user interaction with the computing device 300, an input device 345 can represent any number of input mechanisms, such as a microphone for speech, a touch-sensitive screen for gesture or graphical input, keyboard, mouse, motion input, speech and so forth. An output device 335 can also be one or more of a number of output mechanisms known to those of skill in the art. In some instances, multimodal systems can enable a user to provide multiple types of input to communicate with the computing device 300. The communications interface 340 can generally govern and manage the user input and system output. There is no restriction on operating on any particular hardware arrangement and therefore the basic features here may easily be substituted for improved hardware or firmware arrangements as they are developed.

Storage device 330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 325, read only memory (ROM) 320, and hybrids thereof.

The storage device 330 can include software modules 332, 334, 336 for controlling the processor 310. Other hardware or software modules are contemplated. The storage device 330 can be connected to the system bus 305. In one aspect, a hardware module that performs a particular function can include the software component stored in a computer-readable medium in connection with the necessary hardware components, such as the processor 310, bus 305, display 335, and so forth, to carry out the function.

FIG. 3B illustrates a computer system 350 having a chipset architecture that can be used in executing the described method and generating and displaying a graphical user interface (GUI). Computer system 350 is an example of computer hardware, software, and firmware that can be used to implement the disclosed technology. System 350 can include a processor 355, representative of any number of physically and/or logically distinct resources capable of executing software, firmware, and hardware configured to perform identified computations. Processor 355 can communicate with a chipset 360 that can control input to and output from processor 355. In this example, chipset 360 outputs information to output 365, such as a display, and can read and write information to storage device 370, which can include magnetic media, and solid state media, for example. Chipset 360 can also read data from and write data to RAM 375. A bridge 380 for interfacing with a variety of user interface components 385 can be provided for interfacing with chipset 360. Such user interface components 385 can include a keyboard, a microphone, touch detection and processing circuitry, a pointing device, such as a mouse, and so on. In general, inputs to system 350 can come from any of a variety of sources, machine generated and/or human generated.

Chipset 360 can also interface with one or more communication interfaces 390 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 355 analyzing data stored in storage 370 or 375. Further, the machine can receive inputs from a user via user interface components 385 and execute appropriate functions, such as browsing functions by interpreting these inputs using processor 355.

It can be appreciated that exemplary systems 300 and 350 can have more than one processor 310 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method for global traffic optimization, the method comprising:
receiving a client service request from a client device at a global traffic optimizer server;
identifying a set of service providers capable of servicing the client service request, the set of service providers including at least a first service provider located at a first data center and a second service provider located at a second data center, wherein the first data center and the second data center are located at different geographic locations;
identifying an optimal service provider best suited to service the client service request based on a geographic location of the client device and combination health scores describing service quality of each of the set of service providers, wherein each combination health score is based on a combination of a first health metric and a second health metric broadcast periodically by the respective service provider; and
routing the client service request to the optimal service provider for servicing based on the respective combination health score for each service provider.

2. The method of claim 1, wherein the first health metric and the second health metric include at least one of central processing unit (CPU) usage, bandwidth, memory usage, connectivity, service providers network status, network latency, or user capacity saturation.

3. The method of claim 1, further comprising:
transmitting requests to the set of service providers capable of servicing the client request for the health metrics; and
receiving the health metrics from the set of service providers in response to the requests.

4. The method of claim 1, wherein the optimal service provider transmits a set of requested data to the client device in response to the client service request.

5. (canceled)

6. The method of claim 1, wherein identifying the optimal service provider based on the combination health scores for each service provider comprises selecting one of the set of service providers based on having the highest combination health score.

7. The method of claim 1, wherein the set of service providers includes at least two service providers located at the first data center.

8. A system for global traffic optimization, the system comprising:
one or more computer processors; and
a memory storing instructions executable by the one or more computer processors to:
receive a client service request from a client device at a global traffic optimizer server,
identify a set of service providers capable of servicing the client service request, the set of service providers including at least a first service provider located at a first data center and a second service provider located at a second data center, wherein the first data center and the second data center are located at different geographic locations,
identify an optimal service provider best suited to service the client service request based on a geographic location of the client device and combination health scores describing service quality of each of the set of service providers, wherein each combination health score is based on a combination of a first health metric and a second health metric broadcast periodically by the respective service provider, and
route the client service request to the optimal service provider for servicing based on the respective combination health score for each service provider.

9. The system of claim 8, wherein the first health metric and the second health metric include at least one of central processing unit (CPU) usage, bandwidth, memory usage, connectivity, service providers network status, network latency, or user capacity saturation.

10. The system of claim 8, wherein the processors execute further instructions to:
transmit requests to the set of service providers capable of servicing the client request for the health metrics; and
receive the health metrics from the set of service providers in response to the requests.

11. The system of claim 8, wherein the processors execute further instructions to:
receive a set of requested data from the optimal service provider in response to the client request; and
transmit the set of requested data to the client device.

12. (canceled)

13. The system of claim 8, wherein the processors identify the optimal service provider based on the combination health scores for each service provider by selecting one of the set of service providers based on having the highest combination health score.

14. The system of claim 8, wherein the set of service providers includes at least two service providers located at the first data center.

15. A non-transitory computer-readable storage medium, having embodied thereon instructions executable by a processor to perform a method for global traffic optimization, the method comprising:
receiving a client service request from a client device at a global traffic optimizer server;
identifying a set of service providers capable of servicing the client service request, the set of service providers including at least a first service provider located at a first data center and a second service provider located at a second data center, wherein the first data center and the second data center are located at different geographic locations;
identifying an optimal service provider best suited to service the client service request based on a geographic location of the client device and combination health scores describing service quality of each of the set of service providers, wherein each combination health score is based on a combination of a first health metric and a second health metric broadcast periodically by the respective service provider; and
route the client service request to the optimal service provider for servicing based on the respective combination health score for each service provider.

16. The non-transitory computer-readable medium of claim 15, wherein the first health metric and the second health metric include at least one of central processing unit (CPU) usage, bandwidth, memory usage, connectivity, service providers network status, network latency, or user capacity saturation.

17. The non-transitory computer-readable medium of claim 15, further comprising instructions executable to:
transmit requests to the set of service providers capable of servicing the client request for the health metrics; and
receive the health metrics from the set of service providers in response to the requests.

18. The non-transitory computer-readable medium of claim 15, further comprising instructions executable to:
receive a set of requested data from the optimal service provider in response to the client request; and
transmit the set of requested data to the client device.

19. (canceled)

20. The non-transitory computer-readable medium of claim 15, wherein identifying the optimal service provider based on the combination health scores for each service provider comprises selecting one of the set of service providers based on having the highest combination health score.
